(19) United States
(12) Patent Application Publication
(10) Pub. No.: US 2020/0053479 A1
(43) Pub. Date: Feb. 13, 2020

(54) SPEAKER MODULE

(71) Applicant: AAC Technologies Pte. Ltd., Singapore city (SG)

(72) Inventor: Xiaojiang Gu, Shenzhen (CN)

(21) Appl. No.: 16/530,986

(22) Filed: Aug. 2, 2019

(30) Foreign Application Priority Data
Aug. 10, 2018 (CN) 201821296077.8

(51) Int. Cl. H04R 9/06; H04R 1/02; H04R 9/02

(52) U.S. Cl. CPC H04R 9/06; H04R 1/021; H04R 2400/11; H04R 2499/11; H04R 9/02

(57) ABSTRACT

The present disclosure relates to a speaker, comprising a housing having a receiving space; and a magnetic system and a vibration system received in the receiving space, the vibration system has a diaphragm, the housing comprises a front cover disposed adjacent to the diaphragm and a basin frame covered by the front cover to form the receiving space, the front cover and the diaphragm form a front cavity, the front cover is provided with a penetrating sound output hole in communication with the front cavity, and the front cover comprises an inner surface adjacent to the diaphragm and an outer surface opposite to the inner surface, the outer surface of the front cover is adhered with a first net cloth, and the inner surface of the front cover is adhered with a second net cloth, both the first net cloth and the second mesh cover the sound output hole.

### TECHNICAL FIELD

The present disclosure relates to the field of sound generation, in particular to a speaker module.

### BACKGROUND

As the mobile internet times are coming, the number of smart mobile devices continues to rise. Among many mobile devices, mobile phones are undoubtedly the most common and most portable mobile terminal devices. At present, the functions of mobile phones are extremely diverse, one of which is to provide high-quality music. Therefore, A speaker in the mobile phone is one of the prerequisites for implementing this high quality music function.

Generally, a speaker includes a basin frame that constitutes a housing, a magnetic circuit system fixed within the basin frame, and a vibration system configured to interact with the magnetic circuit system to generate vibration. The magnetic circuit system generally includes a magnetic bowl, a magnetic steel fixed at a central position of the magnetic bowl, and a magnetic gap formed between the magnetic bowl and the magnetic steel; the vibration system generally includes a voice coil partially extending into the magnetic gap and a diaphragm connected to the voice coil. When an electrical signal containing an audio signal is provided to the voice coil, the voice coil interacts with the magnetic field of the magnetic circuit system to generate an ampere force. Subjecting to the ampere force, the voice coil realizes reciprocating vibration, thereby driving the diaphragm to vibrate, and thus generating sound wave radiation.

However, the inventor of the present disclosure found that with the development of the intelligent mobile phones, the media contents for mobile phones is increasing, and user's requirement for sound quality of the media contents is also increasing; and, among many factors affecting the sound quality, the acoustic resistance of the speaker is one of the most important factors. Thus, how to adjust the acoustic resistance in a better way becomes important for improving the sound quality.

### BRIEF DESCRIPTION OF THE DRAWINGS

FIG. 1 is a perspective view illustrating a sound module according to the first embodiment of the present disclosure;

FIG. 2 is an exploded view illustrating a sound module according to the first embodiment of the present disclosure;

FIG. 3 is a cross-sectional view taken along line A-A of FIG. 1.

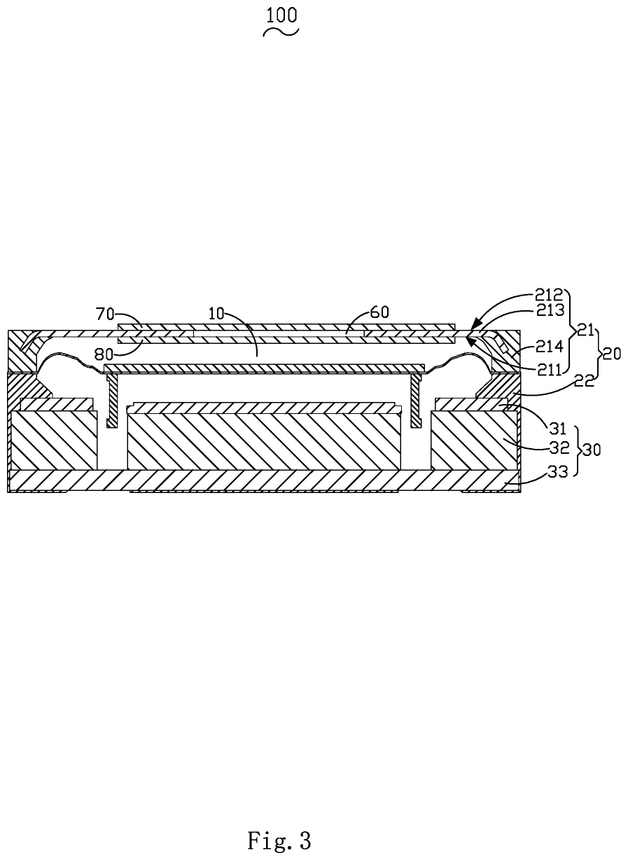

### DETAILED DESCRIPTION

The embodiments of the present disclosure will be described in detail below with reference to the accompanying drawings, in order to make the purpose, the technical solution and the advantageous effect more clear. However, it will be understood by those skilled in the art that, in the various embodiments of the present disclosure, numerous technical details are set forth in order to provide a better understanding of the disclosure. However, the technical solutions claimed in the present disclosure could also be realized without these technical details, and various changes and modifications made based on the following embodiments.

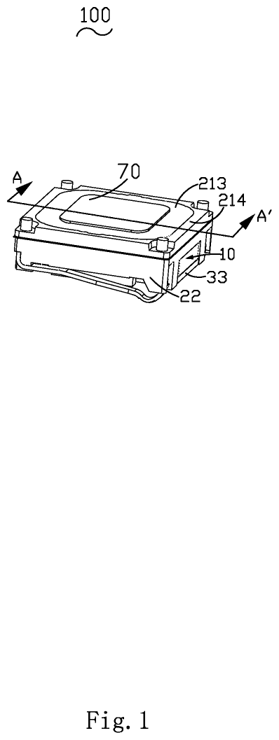

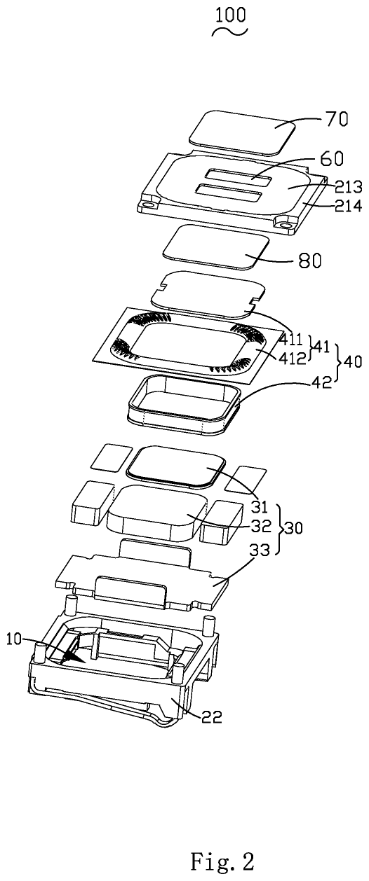

The first embodiment of the present disclosure relates to a speaker module 100. As shown in FIGS. 1 and 2, the speaker module 100 includes a housing 20 having a receiving space 10, and a magnetic circuit system 30 and a vibration system 40 received in the receiving space 10. The magnetic circuit system 30 includes a pole core 31, a magnetic steel 32 and a magnetic bowl 33, the pole core 31 and the magnetic bowl 33 are respectively connected to the magnetic steel 32; the vibration system 40 includes a diaphragm 41 and a voice coil 42, the diaphragm 41 and the voice coil 42 are connected and fixed to each other, and the diaphragm 41 includes a dome 411 and a folding ring 412 connected to the dome 411. The housing 20 includes a front cover 21 disposed adjacent to the diaphragm 41 and a basin frame 22 covered by the front cover 21 to form the receiving space 10. The front cover 21 and the diaphragm 41 jointly form a front cavity 50. The front cover 21 is provided with a sound output hole 60. The sound output hole 60 is disposed by penetrating through the front cover 21 and is in communication with the front cavity 50. The front cover 21 includes an inner surface 211 adjacent to the diaphragm 41, and an outer surface 212 opposite to the inner surface 211 and away from the diaphragm 41. The outer surface 212 is adhered with a first net cloth 70, and the inner surface 211 is adhered with a second net cloth 80, both the first net cloth 70 and the second mesh 80 cover the sound output hole 60.

Compared with the prior art, the speaker module 100 provided by the first embodiment of the present disclosure includes a first net cloth 70 adhered to the outer surface 212 of the front cover 21 and a second net cloth 80 adhered to the inner surface 211 of the front cover 21. The front cover 21 is disposed adjacent to the diaphragm 41, and forms a front cavity 50 together with the diaphragm 41, the front cover 21 is provided with a sound output hole 60 penetrating therethrough and in communication with the front cavity 50, and the sound generated by vibration of the diaphragm 41 is mainly propagated outwardly through the front cavity 50 and the sound output hole 60; therefore, providing the second net cloth 80 and the first net cloth 70 on both the inner surface and the outer surface of the front cover 21 would adjust the acoustic resistance of the speaker module 100 in a better way. In addition, since both the first net cloth 70 and the second net cloth 80 cover the sound output hole 60, the external impurities could be prevented from entering into the speaker module 100 through the sound output hole 60 effectively, thereby improving the speaker module 100 in terms of preventing the entry of impurities.

Preferably, there may be a plurality of the sound output holes 60, and both the first net cloth 70 and the second net cloth 80 cover the plurality of sound output holes 60. Both the first net cloth 70 and the second net cloth 80 covering the plurality of sound output holes 60 refers to that all the sound output holes 60 are covered, which may effectively prevent impurities from entering the inside of the speaker module 100 through the sound output holes 60.

Specifically, in the present embodiment, the number of the sound output holes 60 is two, and the two sound output holes 60 are spaced apart.

Further, the front cover 21 includes a cover plate 213 and a frame 214, and the frame 214 is disposed around the cover plate 213; and the sound output hole 60 is disposed on the cover plate 213.

More preferably, in the present embodiment, the frame 214 and the cover plate 213 are integrally injection molded. The cover plate 213 is integrally modeled with the frame 214, thus the strength of the front cover 21 may be effectively improved. It shall be understood that the integral injection molding of the frame 214 and the cover plate 213 is only one specific implementation according to the present disclosure. In actual applications, in addition to the integral injection molding, certain modification may be made according to actual needs.

In the present embodiment, the cover plate 213 is a steel sheet. It shall be understood that the cover plate 213 may also be made of other materials, such as plastics etc., and the specific material could be selected according to actual needs.

It should be noted that, in the present embodiment, the first net cloth 70 and the second net cloth 80 are mesh net cloths. In addition, the first net cloth 70 and the second net cloth 80 in this embodiment may also be metal net cloths. It shall be understood that in addition to metal and mesh, the first net cloth 70 and the second net cloth 80 may also be cloths made of other materials, such as chemical fiber materials (enumeration thereof are omitted herein), and a specific material thereof may be selected according to actual needs.

In addition, in the present embodiment, the first net cloth 70 and the second net cloth 80 are adhered to the outer surface 212 and the inner surface 211 by glue, or the first net cloth 70 and the second net cloth 80 are fixed to the outer surface 212 and the inner surface 211 by hot melting. Of course, the above two methods may also be combined together for adhering the first net cloth 70 and the second net cloth 80 to the outer surface 212 and the inner surface 211. It shall be understood that there are still many methods for fixing the first net cloth 70 and the second net cloth 80, and a specific method may be selected according to the actual situation (enumeration thereof are omitted herein). The implementation of the embodiments of the present disclosure would not be affected regardless of the manner employed for fixing the first net cloth 70 and the second mesh 80.

Those skilled in the art may understand that the above embodiments are specific embodiments for implementing the present disclosure, and in actual applications, various changes may be made to the form or the details of the technical solutions without departing from the spirit and scope of the present disclosure.

What is claimed is:

1. A speaker module comprising: a housing having a receiving space; and a magnetic system and a vibration system received in the receiving space, wherein, the vibration system has a diaphragm, the housing comprises a front cover disposed adjacent to the diaphragm and a basin frame covered by the front cover to form the receiving space, the front cover and the diaphragm form a front cavity, the front cover is provided with a penetrating sound output hole in communication with the front cavity, and the front cover comprises an inner surface adjacent to the diaphragm and an outer surface opposite to the inner surface and away from the diaphragm, wherein,
the outer surface of the front cover is adhered with a first net cloth, the inner surface of the front cover is adhered with a second net cloth, and both the first net cloth and the second mesh cover the sound output hole.

2. The speaker module according to claim 1, wherein, the speaker module comprises a plurality of sound output holes, and both the first net cloth and the second net cloth cover the plurality of sound output holes.

3. The speaker module according to claim 2, wherein, the speaker module comprises two sound output holes spaced apart from each other.

4. The speaker module according to claim 1, wherein, the front cover comprises a cover plate, and a frame disposed around the cover plate and fixed to the basin frame, wherein, the sound output hole is disposed on the cover plate.

5. The speaker module according to claim 4, wherein, the cover plate is a steel sheet.

6. The speaker module according to claim 5, wherein, the cover plate and the frame are integrally injection molded.

7. The speaker module according to claim 1, wherein the first net cloth and the second net cloth are mesh net cloths.

8. The speaker module according to claim 1, wherein the first net cloth and the second net cloth are metal net cloths.

9. The speaker module according to claim 1, wherein, the first net cloth and the second net cloth are adhered to the outer surface and the inter surface by glue.

10. The speaker module according to claim 1, wherein, the first net cloth and the second net cloth are adhered to the outer surface and the inter surface by hot melting.
